(19) United States
(12) Patent Application Publication
(10) Pub. No.: US 2019/0235559 A1
(43) Pub. Date: Aug. 1, 2019

(54) VOLTAGE REFERENCE AND STARTUP CIRCUIT HAVING LOW OPERATING CURRENT

(71) Applicant: NXP USA, INC., AUSTIN, TX (US)

(72) Inventors: Ahmad Dashtestani, Austin, TX (US); Alma Anderson, Chandler, AZ (US)

(21) Appl. No.: 15/881,940

(22) Filed: Jan. 29, 2018

(51) Int. Cl. G05F 3/16; G05F 1/46

(52) U.S. Cl. CPC G05F 3/16; G05F 1/461

(57) ABSTRACT

A startup circuit for a voltage reference circuit is provided. The startup circuit includes first, second, and third transistors. The first transistor has a first current electrode coupled to the voltage reference circuit, a control electrode, and a second current electrode coupled to a ground terminal. The second transistor has a first current electrode and a control electrode both coupled to a power supply voltage terminal, and a second current electrode. The third transistor has a first current electrode coupled to the second current electrode of the second transistor and to the control electrode of the first transistor, a control electrode coupled to the voltage reference circuit, and a second current electrode coupled to the ground terminal. During application of a power supply voltage, the second transistor is off, thus providing only a leakage current to the gate of the first transistor. This provides for reliable startup with very low residual current after startup is complete.

### BACKGROUND

### Field

This disclosure relates generally to circuits, and more particularly, to a voltage reference and startup circuit having low operating current.

### Related Art

In integrated circuits, voltage reference circuits are used to provide reference voltages and currents for other circuit blocks. A bandgap voltage reference circuit is a type of reference circuit that uses the bandgap of silicon to provide a stable precision reference voltage. One type of voltage reference circuit has two stable states, an OFF state with zero current and an ON state with proper currents to provide the needed voltage. An example of this type of voltage reference circuit is illustrated in FIG. 1 and will be discussed later. To avoid the voltage reference circuit starting up in the OFF state, a startup circuit may be used to ensure a current is flowing when the voltage reference circuit is powered up.

There are two types of voltage reference startup circuits: dynamic startup circuits and static startup circuits. In dynamic startup circuits a pulse or clock signal from another digital circuit block or from another source external to the integrated circuit is used to activate and then deactivate the startup circuit after power up. Startup circuit 17 in FIG. 3 is an example of a dynamic startup circuit. In static startup circuits, a feedback from the voltage reference circuit turns the startup circuit off. Startup circuits 13 and 15 in FIG. 1 and FIG. 2 are examples of static startup circuits. There may be one circuit branch with current flow from the power supply to ground that is always on, causing an undesirable residual current flow. To reduce the current, a resistor with a very large resistance value may be used. However, in ultra-low power applications, to keep the current low after startup, the resistor would have to be very large so that the implementation of the startup circuit would not be practical.

FIG. 1 illustrates, in schematic diagram form, voltage reference and startup circuit 10 in accordance with the prior art. Voltage reference and startup circuit 10 includes voltage reference circuit 12, and startup circuit 13. Voltage reference circuit 12 includes P-channel transistors 16 and 18, N-channel transistors 20 and 22, and resistor 24. P-channel transistors 16 and 18 are coupled together to form a current mirror. An output reference voltage may be provided to another circuit (not shown) at the drain of P-channel transistor 16. Startup circuit 13 includes a resistor 30 and N-channel transistors 26 and 28.

Without startup circuit 13, voltage reference circuit 12 is stable when the current is zero in both of the branches, and voltage reference circuit 12 is stable when the current is greater than zero in both branches. To ensure that voltage reference circuit 12 powers up with a positive current in both branches, startup circuit 13 is used to “kick start” voltage reference circuit 12. As the power supply voltage VDD increases, a current through resistor 30 will pull the gate of N-channel transistor 26 high causing the drain of N-channel transistor 26 to pull the gates of P-channel transistors 16 and 18 to VSS. Diode-connected transistor 18 will turn on and conduct a current. The current is mirrored by P-channel transistor 16 and voltage reference circuit 12 “wakes up.” Once voltage reference circuit 12 is on, N-channel transistor 28 turns on causing N-channel transistor 26 to turn off. A current through transistor 26 goes to zero, but the current through resistor 30 and N-channel transistor 28 remains, thus wasting power. The amount of wasted current can be reduced by increasing the resistance of resistor 30. However, the surface area dedicated to implementing resistor 30 will increase with increasing resistance.

FIG. 2 illustrates, in schematic diagram form, a voltage reference and startup circuit 34 in accordance with the prior art. Voltage reference and startup circuit 34 includes voltage reference circuit 12 and startup circuit 15. Startup circuit 15 is the same as startup circuit 13 except that a long channel P-channel transistor 32 is substituted for resistor 30. The long channel transistor is smaller than a resistor, however, there is still a significant wasted current through transistors 32 and 28 after voltage reference circuit 12 wakes up.

FIG. 3 illustrates, in partial schematic diagram form and partial logic diagram form, voltage reference and startup circuit 38 in accordance with the prior art. Voltage reference and startup circuit 38 include voltage reference circuit 12 and startup circuit 17. Startup circuit 17 includes OR logic gate 40, N-channel transistors 26, 42, and 44, capacitor 46, and inverter 48. When an input A or input B of OR logic gate 40 is provided with a logic high clocked signal such as, for example, a powerup, powerdown, or reset signal, a logic one turns N-channel transistor 42 on. Both the top and bottom plates of capacitor 46 are connected to ground, causing capacitor 46 to discharge. When the logic high clocked signal becomes a logic zero, the top plate of capacitor 46 will be connected to VDD which will force the bottom plate of capacitor 46 to rise near VDD, thus causing N-channel transistor 26 to turn on. The gate of P-channel transistor 18 will be pulled down, causing a current in both branches of the current mirror formed by P-channel transistors 16 and 18. N-channel transistor 44 is made conductive by a bias voltage VB and will quickly discharge capacitor 46, so that the voltage at the gate of transistor 26 is decreased. Once the pulse at the gate of transistor 26 settles to zero volts, transistor 26 turns off and there are no other current paths between VDD and VSS in startup circuit 17. However, unlike startup circuits 13 and 15, startup circuit 17 requires a clocked signal to function, which may add complexity to a circuit design.

Therefore, a need exists for a voltage reference and startup circuit that provides a nearly zero current after startup and that does not require a clocked signal or large resistor.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates, in schematic diagram form, a voltage reference and startup circuit in accordance with the prior art.

FIG. 2 illustrates, in schematic diagram form, another voltage reference and startup circuit in accordance with the prior art.

FIG. 3 illustrates, in partial schematic diagram form and partial logic diagram form, another voltage reference and startup circuit in accordance with the prior art.

FIG. 4 illustrates, in schematic diagram form, a voltage reference and startup circuit in accordance with an embodiment.

FIG. 5 illustrates, in schematic diagram form, a voltage reference and startup circuit in accordance with another embodiment.

### DETAILED DESCRIPTION

Generally, there is provided, a static startup circuit for a voltage reference circuit that has a very low residual current after startup. The voltage reference circuit may be a bandgap voltage reference having two P-channel transistors connected as a current mirror. The startup circuit includes an N-channel transistor configured to become conductive when a power supply voltage is applied to the circuit. The N-channel transistor will then pull down the gate voltage of the P-channel transistors, thus ensuring the P-channel transistors are conductive and providing a current for the voltage reference circuit. The gate of the N-channel transistor is biased through a P-channel transistor that is coupled so that it stays off, or substantially non-conductive, as the power supply voltage increases. In one embodiment, the gate of the P-channel transistor is connected to a power supply terminal so that the voltage provided to the gate of the P-channel transistor is always high when the power supply voltage is applied to the circuit. When the power supply voltage increases, a leakage current through the substantially non-conductive P-channel transistor pulls up the gate of the N-channel transistor. Because the P-channel transistor of the startup circuit is off, only a very small leakage current flows to pull up the gate of the P-channel transistors of the voltage reference circuit. Also, the P-channel transistor can be small compared to an equivalent valued resistor, so that the surface area needed to implement the startup circuit is much smaller. After startup, the leakage current though the startup P-channel transistor is in the pico amps range, or very near zero amps without the need to implement a very large valued resistor, or the need for a clocked signal as in a dynamic startup circuit. In another embodiment, the leakage current is provided by using a reverse-biased PN junction.

In one embodiment, there is provided, a startup circuit for a voltage reference circuit, the startup circuit including: a first transistor having a first current electrode coupled to the voltage reference circuit, a control electrode, and a second current electrode coupled to a ground terminal; a second transistor having a first current electrode and a control electrode both coupled to a power supply voltage terminal, and a second current electrode; and a third transistor having a first current electrode coupled to the second current electrode of the second transistor and to the control electrode of the first transistor, a control electrode coupled to the voltage reference circuit, and a second current electrode coupled to the ground terminal. The voltage reference circuit may provide a reference voltage based on a bandgap of silicon. The second transistor may be characterized as being a P-channel transistor, and wherein during application of a power supply voltage to the power supply voltage terminal, the P-channel transistor may remain substantially non-conductive so that a bias voltage at the control electrode of the first transistor is provided by a leakage current through the second transistor. The first and third transistors may be characterized as being N-channel transistors, and the second transistor may be characterized as being a P-channel transistor. The voltage reference circuit may include a current mirror, and wherein the first current electrode of the first transistor may be coupled to the current mirror to ensure that the current mirror is biased into conduction when a power supply voltage is provided to the power supply voltage terminal. The voltage reference circuit may include: a first P-channel transistor having a source coupled to the power supply voltage terminal, a gate coupled to the first current electrode of the first transistor, and a drain; a second P-channel transistor having a source coupled to the power supply voltage terminal, a gate and a drain both coupled to the gate of the first P-channel transistor; a first N-channel transistor having a drain and a gate both coupled to the drain of the first P-channel transistor, and a source coupled to the ground terminal; and a second N-channel transistor having a drain coupled to the drain of the second P-channel transistor, a gate coupled to the gate of the first N-channel transistor, and source coupled to the ground terminal. The startup circuit may further include a resistive element coupled between the source of the second N-channel transistor and the ground terminal. A power supply voltage may be applied to the power supply voltage terminal, and a voltage difference between the first current electrode and the control electrode may substantially zero volts. The second transistor may be larger than the third transistor, and a leakage current through the second transistor may include a subthreshold current.

In another embodiment, there is provided, a circuit including: a voltage reference circuit; and a startup circuit, the startup circuit including: a first N-channel transistor having a drain coupled to the voltage reference circuit, a gate, and a source coupled to a ground terminal; a reverse-biased PN junction having a first terminal coupled to power supply voltage terminal, and a second terminal coupled to the gate of the first N-channel transistor; a second N-channel transistor having a drain coupled to the second terminal of the PN junction, a gate coupled to the voltage reference circuit, and a source coupled to the ground terminal, wherein during application of a power supply voltage to the power supply voltage terminal, a voltage at the gate of the first N-channel transistor is provided by a leakage current through the reverse-biased PN junction. The reverse-biased PN junction may be larger than the second N-channel transistor. The voltage reference circuit may be characterized as being a bandgap voltage reference circuit. The voltage reference circuit may include a current mirror, and wherein the drain of the first N-channel transistor may be coupled to the current mirror to ensure that the current mirror is biased into conduction during the application of the power supply voltage to the power supply voltage terminal. The leakage current through the reversed-biased PN junction may include a junction leakage current. The voltage reference circuit may include: a first P-channel transistor having a source coupled to the power supply voltage terminal, a gate coupled to the drain of the first N-channel transistor, and a drain; a second P-channel transistor having a source coupled to the power supply voltage terminal, a gate and a drain both coupled to the gate of the second P-channel transistor; a third N-channel transistor having a drain and a gate both coupled to the drain of the first P-channel transistor, and a source coupled to the ground terminal; and a fourth N-channel transistor having a drain coupled to the drain of the second P-channel transistor, a gate coupled to the gate of the third N-channel transistor, and source coupled to the ground terminal.

In yet another embodiment, there is provided, a circuit including: a voltage reference circuit including: a first P-channel transistor having a source coupled to the power supply voltage terminal, a gate, and a drain; a second P-channel transistor having a source coupled to the power supply voltage terminal, a gate and a drain both coupled to the gate of the first P-channel transistor; a first N-channel transistor having a drain and a gate both coupled to the drain of the first P-channel transistor, and a source coupled to a ground terminal; and a second N-channel transistor having a drain coupled to the drain of the second P-channel transistor, a gate coupled to the gate of the first N-channel transistor, and source coupled to the ground terminal; and a startup circuit including: a third N-channel transistor having a drain coupled to the gates of the first and second P-channel transistors, a gate, and a source coupled to the ground terminal; a third P-channel transistor having a source coupled to the power supply voltage terminal, a gate, and a drain coupled to the gate of the third N-channel transistor, wherein a gate-to-source voltage of the third P-channel transistor is substantially zero volts during application of a power supply voltage to the power supply voltage terminal; and a fourth N-channel transistor having a drain coupled to the drain of the third P-channel transistor, a gate coupled to the drain of the first P-channel transistor, and a source coupled to the ground terminal. The gate of the third P-channel transistor may be coupled to the power supply voltage terminal. The third P-channel transistor may be larger than the fourth N-channel transistor. The gate of the third N-channel transistor may be biased by a leakage current through the third P-channel transistor during the application of the power supply voltage. The voltage reference circuit may be characterized as being a bandgap voltage reference circuit.

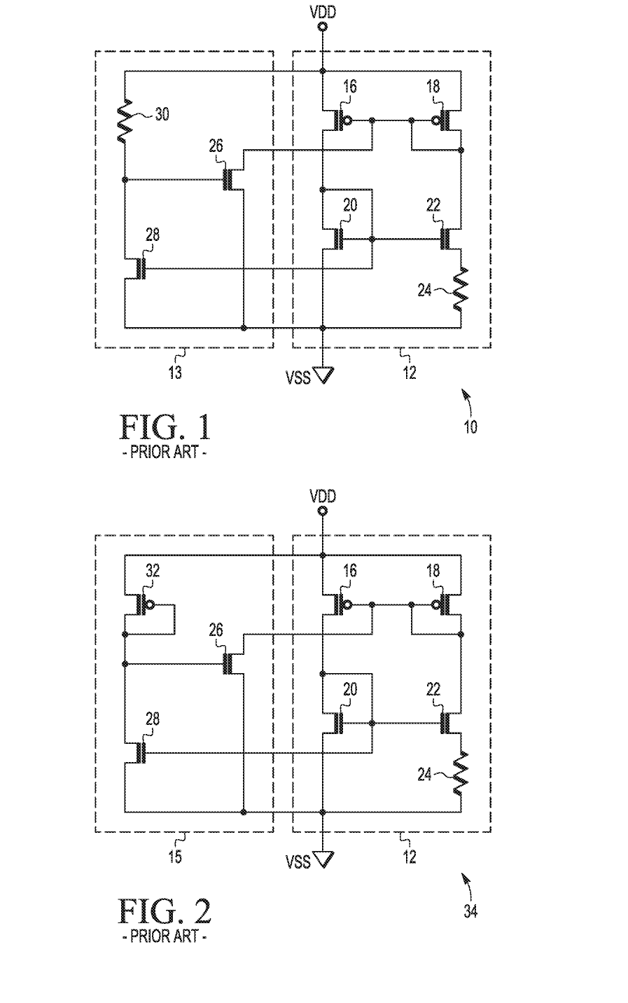

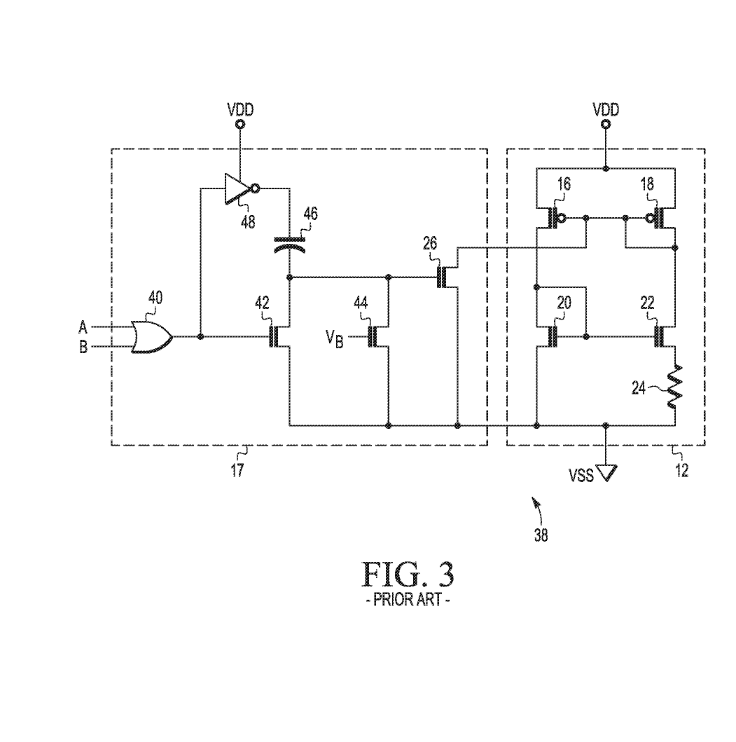

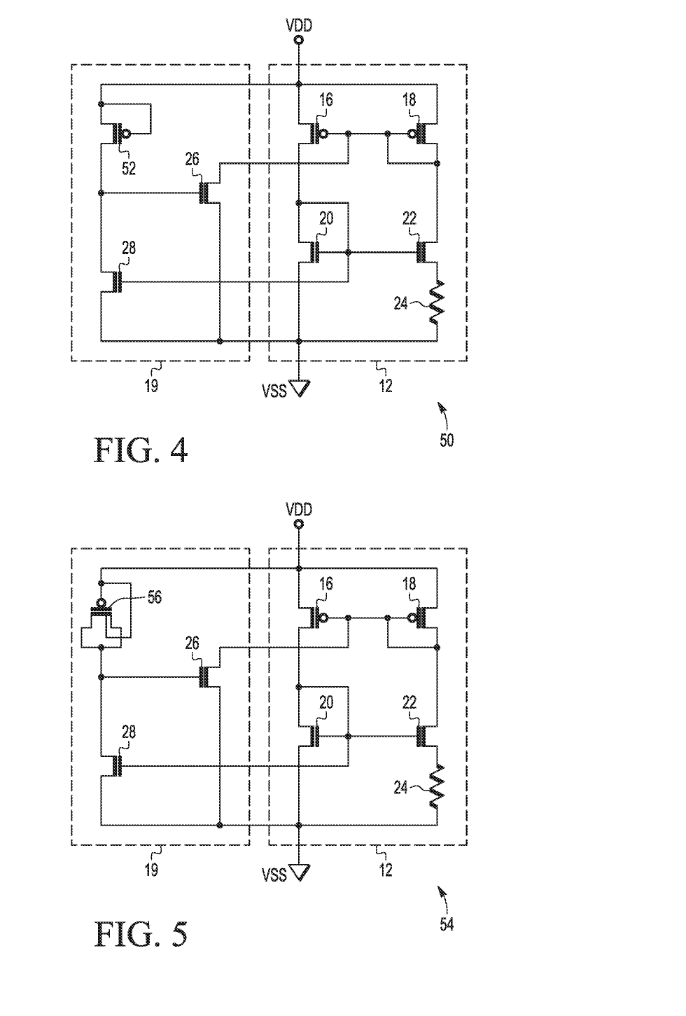

FIG. 4 illustrates, in partial schematic diagram form, voltage reference and startup circuit 50 in accordance with an embodiment. Voltage reference and startup circuit 50 includes voltage reference circuit 12 and startup circuit 19. Voltage reference circuit 12 is the same as voltage reference circuit 12 in FIG. 1 through FIG. 3, and includes P-channel transistors 16 and 18, N-channel transistors 20 and 22, and resistor 24. P-channel transistors 16 and 18 are coupled together to form a current mirror. An output voltage may be provided at the drain of P-channel transistor 16. In one embodiment, voltage reference circuit 12 provides an output voltage based on the bandgap of silicon. Startup circuit 19 includes P-channel transistor 52 and N-channel transistors 26 and 28. As illustrated, the disclosed embodiment uses complementary metal oxide semiconductor (CMOS) transistors. Other embodiments may use different transistor types.

In voltage reference circuit 12, P-channel transistor 16 has a source (current electrode) connected to a power supply voltage terminal labeled “VDD”, a gate (control electrode), and a drain (current electrode). P-channel transistor 18 has a source connected to VDD, and a gate and a drain both connected to the gate of P-channel transistor 18. N-channel transistor 20 has a drain and a gate both connected to the drain of P-channel transistor 16, and a source connected to a power supply voltage terminal labeled “VSS”. N-channel transistor 22 has a drain connected to the drain of P-channel transistor 18, a gate connected to the drain of P-channel transistor 16, and a source connected to VSS. Note that in one embodiment, VDD is a positive power supply voltage and VSS is ground. In another embodiment, the power supply voltage provided to power supply voltage terminals VDD and VSS may be different.

In startup circuit 19, N-channel transistor 26 has a drain connected to the gates of P-channel transistors 16 and 18, a gate, and a source connected to VSS. P-channel transistor 52 has a gate and a source both connected to VDD, and a drain connected to the gate of N-channel transistor 26. N-channel transistor 28 has a drain connected to the drain of P-channel transistor 52, a gate connected to the drain of P-channel transistor 16, and a source connected to VSS.

Startup circuit 19 is provided to ensure that voltage reference circuit 12 always powers up correctly when a power supply voltage is applied to power supply voltage terminal VDD. Voltage reference circuit 12 is powered up correctly when a current flows through both branches, or legs, of voltage reference circuit 12. P-channel transistors 16 and 18 are coupled together to provide a current mirror. Transistors 16 and 20 form one branch and transistors 18 and 22 form the other branch. P-channel transistor 52 is connected so that a gate-to-source voltage (VGS) is zero during startup when a power supply voltage is applied. In one embodiment, the gate and the source of P-channel transistor 52 are both connected to power supply voltage terminal VDD. With the gate and source connected together this way, P-channel transistor 52 does not turn on. A channel does not form between the source and drain of transistor 52 because the VGS is zero. A zero VGS subthreshold leakage current through P-channel transistor 52 is used to pull the gate of N-channel transistor 26 high enough to turn N-channel transistor 26 on. P-channel transistor 52 is sized large relative to N-channel transistor 28 to provide sufficient leakage current to turn on N-channel transistor 26. In one embodiment, P-channel transistor 52 is larger than N-channel transistor 28. Simulations may be used to size the transistors so that P-channel transistor 52 will provide sufficient leakage to pull up the gate of N-channel transistor 26 across process and temperature variations. The conductive N-channel transistor 26 pulls down the gate voltage of P-channel transistors 16 and 18. Diode-connected P-channel transistor 18 turns on so that current flows in both branches of the current mirror and voltage reference circuit 12 begins to operate. After current flows in the branches, the voltage at the gates of N-channel transistors 20, 22, and 28 increases. When the gate of N-channel transistor 28 is high, N-channel transistor 28 is conductive causing the drain of N-channel transistor 28 to become low, or near VSS. The low drain voltage of N-channel transistor 28 pulls the gate voltage of N-channel transistor 26 low so that N-channel transistor 26 turns off, and removes a current path in startup circuit 19. The startup of voltage reference circuit 12 is complete. Because startup circuit 19 is a static type of startup circuit, it is not disabled by a clock signal.

The leakage current of P-channel transistor 52 provides the initial current to get voltage reference circuit 12 started. Except during operation at, for example, high temperature, the current provided by P-channel transistor 52 is very low, e.g., in the pico amps range. Even during high temperature the current is still low, in the nano amps range, and nearly negligible. P-channel transistor 52 is sized large compared to N-channel transistor 28 so that the zero VGS leakage current is large compared to the zero VGS leakage current of N-channel transistor 28. This allows the startup VGS voltage of P-channel transistor 26 to be held high by the unbalanced leakage currents across temperature and process variations. The leakage currents may be dominated by subthreshold currents, but even junction leakage currents can be used. The use of unbalanced leakage current guarantees the startup for quasi DC (direct current) powerup conditions. Furthermore, sizing P-channel transistor 52 relatively larger than N-channel transistors 26 and 28 also results in a capacitance unbalance so that the gate of N-channel transistor 26 will also tend to be pulled up by the capacitance for fast power supply ramp up conditions. This will improve the startup time as compared to the startup time of leakage only gate charging. After the gate of N-channel transistor 28 is pulled up enough to pull the gate of N-channel transistor 26 to VSS, N-channel transistor 26 turns off. All current paths are removed except for the leakage of P-channel transistor 52, which is small enough (pico amps range) to be negligible.

FIG. 5 illustrates, in schematic diagram form, voltage reference and startup circuit 54 in accordance with another embodiment. Voltage reference and startup circuit 54 is the same as voltage reference and startup circuit 50 except that P-channel transistor 52 is replaced by a reverse-biased PN junction. In one embodiment, the reverse-biased PN junction is implemented using a P-channel transistor 56. Transistor 56 has a gate connected to power supply voltage terminal VDD. The source and drain of transistor 56 are connected together and to the gate of transistor 26. A bulk, or body, terminal of transistor 56 is connected to VDD. In another embodiment, the reverse-biased PN junction may be implemented on a semiconductor device without forming a complete transistor. For example, an Nwell is connected to power supply voltage terminal VDD, and a P+ active (source/drain type) region forms the P side of the diode. The diode does not need a gate oxide and uses components present in the P-channel transistor 56, namely the Nwell and the P active regions. During startup, like transistor 52 discussed above, the reverse-biased PN junction is substantially non-conductive and provides leakage current to bias the gate of transistor 26. However, the reverse-biased PN junction provides primarily junction leakage currents. To be able to pull up the voltage at the gate of transistor 26, the reverse-biased PN junction provides a higher leakage current than N-channel transistor 28. One way to ensure a higher leakage current is to make the PN junction larger than transistor 28.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims. Generally, in the above described embodiment, a current electrode is a source or drain and a control electrode is a gate of a metal-oxide semiconductor (MOS) transistor. Other transistor types may be used in other embodiments.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

1. A startup circuit for a voltage reference circuit, the startup circuit comprising:
a first transistor having a first current electrode coupled to the voltage reference circuit, a control electrode, and a second current electrode coupled to a ground terminal;
a second transistor having a first current electrode and a control electrode both directly connected to a power supply voltage terminal, and a second current electrode; and
a third transistor having a first current electrode coupled to the second current electrode of the second transistor and to the control electrode of the first transistor, a control electrode coupled to the voltage reference circuit, and a second current electrode coupled to the ground terminal, wherein the second transistor is larger than the third transistor, and wherein a leakage current through the second transistor comprises a subthreshold current is greater than a leakage current of the third transistor sufficient to pull up the control electrode of the first transistor.

2. The startup circuit of claim 1, wherein the voltage reference circuit provides a reference voltage based on a bandgap of silicon.

3. The startup circuit of claim 1, wherein the second transistor is characterized as being a P-channel transistor, and wherein during application of a power supply voltage to the power supply voltage terminal, the P-channel transistor remains substantially non-conductive so that a bias voltage at the control electrode of the first transistor is provided by a leakage current through the second transistor.

4. The startup circuit of claim 1, wherein the first and third transistors are characterized as being N-channel transistors, and the second transistor is characterized as being a P-channel transistor.

5. The startup circuit of claim 1, wherein the voltage reference circuit comprises a current mirror, and wherein the first current electrode of the first transistor is coupled to the current mirror to ensure that the current mirror is biased into conduction when a power supply voltage is provided to the power supply voltage terminal.

6. The startup circuit of claim 1, wherein the voltage reference circuit comprises:
a first P-channel transistor having a source coupled to the power supply voltage terminal, a gate coupled to the first current electrode of the first transistor, and a drain;
a second P-channel transistor having a source coupled to the power supply voltage terminal, a gate and a drain both coupled to the gate of the first P-channel transistor;
a first N-channel transistor having a drain and a gate both coupled to the drain of the first P-channel transistor, and a source coupled to the ground terminal; and
a second N-channel transistor having a drain coupled to the drain of the second P-channel transistor, a gate coupled to the gate of the first N-channel transistor, and source coupled to the ground terminal.

7. The startup circuit of claim 6, further comprising a resistive element coupled between the source of the second N-channel transistor and the ground terminal.

8. The startup circuit of claim 1, wherein when a power supply voltage is applied to the power supply voltage terminal, a voltage difference between the first current electrode and the control electrode of the second transistor is substantially zero volts.

9. (canceled)

10. A circuit comprising:
a voltage reference circuit; and
a startup circuit, the startup circuit comprising:
a first N-channel transistor having a drain coupled to the voltage reference circuit, a gate, and a source coupled to a ground terminal;
a first P-channel transistor having a gate connected to a power supply voltage terminal, and a source and drain connected together and connected to the gate of the first N-channel transistor; and
a second N-channel transistor having a drain coupled to the source and drain of the first P-channel transistor, a gate coupled to the voltage reference circuit, and a source coupled to the ground terminal,
wherein during application of a power supply voltage to the power supply voltage terminal, a voltage at the gate of the first N-channel transistor is provided by a leakage current through the first P-channel transistor.

11. The circuit of claim 10, wherein the first P-channel transistor is larger than the second N-channel transistor.

12. The circuit of claim 10, wherein the voltage reference circuit is characterized as being a bandgap voltage reference circuit.

13. The circuit of claim 10, wherein the voltage reference circuit comprises a current mirror, and wherein the drain of the first N-channel transistor is coupled to the current mirror to ensure that the current mirror is biased into conduction during the application of the power supply voltage to the power supply voltage terminal.

14. The circuit of claim 10, wherein the leakage current through the first P-channel transistor comprises a leakage current.

15. The circuit of claim 10, wherein the voltage reference circuit comprises:
a second P-channel transistor having a source coupled to the power supply voltage terminal, a gate coupled to the drain of the first N-channel transistor, and a drain;
a third P-channel transistor having a source coupled to the power supply voltage terminal, a gate and a drain both coupled to the gate of the second P-channel transistor;
a third N-channel transistor having a drain and a gate both coupled to the drain of the second P-channel transistor, and a source coupled to the ground terminal; and
a fourth N-channel transistor having a drain coupled to the drain of the third P-channel transistor, a gate coupled to the gate of the third N-channel transistor, and source coupled to the ground terminal.

16. A circuit comprising:
a voltage reference circuit comprising:
a first P-channel transistor having a source coupled to the power supply voltage terminal, a gate, and a drain;
a second P-channel transistor having a source coupled to the power supply voltage terminal, a gate and a drain both coupled to the gate of the first P-channel transistor;
a first N-channel transistor having a drain and a gate both coupled to the drain of the first P-channel transistor, and a source coupled to a ground terminal; and
a second N-channel transistor having a drain coupled to the drain of the second P-channel transistor, a gate coupled to the gate of the first N-channel transistor, and source coupled to the ground terminal; and
a startup circuit comprising:
a third N-channel transistor having a drain coupled to the gates of the first and second P-channel transistors, a gate, and a source coupled to the ground terminal;
a third P-channel transistor having a gate and a source both directly connected to the power supply voltage terminal, and a drain coupled to the gate of the third N-channel transistor, wherein a gate-to-source voltage of the third P-channel transistor is substantially zero volts during application of a power supply voltage to the power supply voltage terminal; and
a fourth N-channel transistor having a drain coupled to the drain of the third P-channel transistor, a gate coupled to the drain of the first P-channel transistor, and a source coupled to the ground terminal.

17. The circuit of claim 16, wherein the gate of the third P-channel transistor is coupled to the power supply voltage terminal.

18. The circuit of claim 16, wherein the third P-channel transistor is larger than the fourth N-channel transistor.

19. The circuit of claim 16, wherein the gate of the third N-channel transistor is biased by a leakage current through the third P-channel transistor during the application of the power supply voltage.

20. The circuit of claim 16, wherein the voltage reference circuit is characterized as being a bandgap voltage reference circuit.
